(19) United States
(12) Patent Application Publication
(10) Pub. No.: US 2026/0173080 A1
(43) Pub. Date: Jun. 18, 2026

(54) Electronic Devices, Methods, Corresponding Systems for Dynamic User Equipment (UE) Capability Reduction Using Real-Time Resource Monitoring

(71) Applicant: Motorola Mobility LLC, Chicago, IL (US)

(72) Inventors: Daniel C Chisu, Franklin Park, IL (US); Armin W Klomsdorf, Chicago, IL (US)

(21) Appl. No.: 18/985,737

(22) Filed: Dec. 18, 2024

(51) Int. Cl. H04W 72/21; H04W 72/044

(52) U.S. Cl. CPC H04W 72/21; H04W 72/044

(57) ABSTRACT

A method in an electronic device involves transmitting a full user equipment (UE) capability information (UCI) message by a communication device upon entering a new location area code (LAC). While the device remains in the LAC, one or more processors monitor network resources and determine a subset of capabilities required for communication. In response to subsequent UCI requests, the communication device transmits a partial UCI message. The method includes marking allocated resources as information elements (IEs) and/or IE values, building the partial UCI message, and starting a guard timer. The partial UCI message comprises a reduced capability list, including elements such as power class, MIMO layers, modulation schemes, and bandwidth. This approach optimizes transmission efficiency and reduces power consumption.

### BACKGROUND

### Technical Field

This disclosure relates generally to electronic devices, and more particularly to electronic devices supporting wireless communication capabilities.

### Background Art

In wireless communication systems, messages are used to provide the network with details about device capabilities. These messages typically occur during initial registration or update procedures.

As wireless communication standards evolve, the complexity and size of these messages have increased significantly. Modern messages can be as large as 2 KB to 8 KB, posing challenges in terms of transmission time, power consumption, and successful reception, especially in areas with weak coverage. The increasing complexity of these messages is particularly pronounced in new systems, where the number of aggregated carriers and supported features can exceed the maximum size of signaling messages, thereby introducing additional delays as the network reassembles the segments. It would be advantageous to have improved electronic devices, systems, and corresponding methods that reduce delays in the establishment of network connections where UE capability messaging is utilized.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates a flow chart for a UE capability update method.

FIG. 3 illustrates one explanatory flow chart for a UE capability update method in accordance with one or more embodiments of the disclosure.

FIG. 4 illustrates one explanatory method in accordance with one or more embodiments of the disclosure.

FIG. 5 illustrates another explanatory method in accordance with one or more embodiments of the disclosure.

FIG. 6 illustrates still another explanatory method in accordance with one or more embodiments of the disclosure.

FIG. 7 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to transmitting, by a communication device of the electronic device, a full user equipment (UE) capability information (UCI) message in response to the communication device receiving a UCI request from at least one network device across a network upon the electronic device entering a new location area code (LAC) and, thereafter, while the electronic device remains in the LAC, monitoring, by one or more processors, resources allocated by the network and resources in use by the one or more processors, determining, in response to the monitoring, a subset of capabilities required by the electronic device to communicate across the network, and, in response to the communication device receiving another UCI request while the electronic device remains in the LAC, causing, by the one or more processors, the communication device to transmit a partial UCI message to the at least one network device across the network. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of using one or more processors that are configured to dynamically reduce a size of a UCI message as a function of real-time resource assignment and utilization by monitoring resources allocated to the communication device by a network with which the communication device is in communication while the electronic device remains within an identified LAC and, after the communication device initially sends a full UCI message upon the electronic device entering the LAC, subsequently causing a communication device to transmit a partial UCI message on a per radio access technology (RAT) basis in response to UCI requests from the network. Indeed, in one or more embodiments the partial UCI message comprises resources marked as mandatory information elements (IEs) and/or information element (IE) values as described herein.

The non-processor circuits may include, but are not limited to, a radio receiver, a radio transmitter, signal drivers, clock circuits, power source circuits, and user input devices. As such, these functions may be interpreted as steps of a method to perform determining, by one or more processors, that the electronic device has entered a new LAC, causing, by the one or more processors in response to receipt of a UCI request from a network, a communication device to transmit a full UCI message to the network, thereafter monitoring, by the one or more processors, network resource assignments and utilization and marking assigned resources as mandatory IEs and/or IE values as partial UE capability information in a memory of the electronic device, constructing, by the one or more processors, a partial UCI message from the mandatory IEs and/or the IE values, and while the LAC within which the electronic device is operating remains unchanged, in response to subsequent UCI requests from the network, transmitting the partial UCI message to the network instead of the full UCI message.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

As noted above, in wireless communication systems, messages that provide the network with details about device capabilities are important. These messages typically occur during initial registration or update procedures.

As wireless communication standards evolve, the complexity and size of these messages have increased significantly. Modern messages can be as large as 2 KB to 8 KB, posing challenges in terms of transmission time, power consumption, and successful reception, especially in areas with weak coverage.

The increasing complexity of these messages is particularly pronounced in new systems, where the number of aggregated carriers and supported features can exceed the maximum size of signaling messages. While some messaging specifications allow for segmenting messages into smaller chunks, this approach introduces additional delays as the network reassembles the segments. This segmentation process can negatively impact the user experience by delaying the establishment of connections and increasing power consumption.

Accordingly, it becomes clear that the increasing complexity and size of UCI messages pose significant challenges in wireless communication systems. To wit, large UCI messages can impact transmission time, power consumption, and successful reception, especially in areas with weak coverage. The segmentation of these messages into smaller chunks, even where allowed by network specifications, introduces additional delays and negatively affects the user experience.

Embodiments of the disclosure contemplate there is thus a need for UE, methods, and corresponding systems that dynamically reduces the size of UCI messages based on real-time resource assignment and utilization. Advantageously, embodiments of the disclosure address the limitations of existing solutions by monitoring network resource assignments and usage, determining a subset of capabilities to report, and transmitting partial UCI messages to the network. Advantageously, embodiments of the disclosure improve transmission efficiency, reduce power consumption, and enhance the overall user experience in wireless communication systems.

In one or more embodiments, embodiments of the disclosure dynamically reduce the size of the UCI messages based on real-time resource monitoring. In one or more embodiments, a system monitors the resources allocated by the network and the resources in use at a given LAC.

In one or more embodiments, upon entering a new LAC, the UE transmits a full UCI message to the network. In one or more embodiments, while the UE remains in the same LAC, the system performs a short throughput test in both downlink and uplink directions while the device is idle.

In one or more embodiments, the system marks the resources that are actually exercised as IEs for the next UCI message in the same LAC. The system builds and stores a partial UCI message using these IEs. In one or more embodiments, when the network requests UCI again within the same LAC, the UE transmits the partial UCI message, thus reducing the size of the UCI message.

In one or more embodiments, the system also monitors the capabilities in use and reports a reduced capability list, which includes elements such as the actual band or carrier aggregation (CA) combination used, power class, inter-RAT band lists, MIMO layers, modulation schemes, and bandwidth. The system can utilize the process at all times in one or more embodiments. In other embodiments, the system can utilize the process only in weak coverage or when the remaining battery charge level is low.

In one or more embodiments, the system starts a guard timer to account for network configuration changes, ensuring that the partial UCI message remains valid within the guard period. If the LAC changes or the guard timer expires, the system resumes the process by transmitting a full UCI message and repeating the monitoring and reduction steps in one or more embodiments.

Thus, in one or more embodiments a method in an electronic device involves transmitting a full UCI message by a communication device of the electronic device. In one or more embodiments, this transmission occurs in response to the communication device receiving a UCI request from at least one network device across a network when the electronic device enters a new LAC.

Thereafter, while the electronic device remains in the LAC, one or more processors monitor resources allocated by the network and resources in use by the one or more processors. In one or more embodiments, the method includes determining, in response to the monitoring, a subset of capabilities required by the electronic device to communicate across the network. In response to the communication device receiving another UCI request while the electronic device remains in the LAC, the one or more processors cause the communication device to transmit a partial UCI message to the at least one network device across the network in one or more embodiments.

Advantageously, embodiments of the disclosure provide a dynamic approach to reducing the size of the UCI message based on real-time resource monitoring. By transmitting a full UCI message upon entering a new LAC and subsequently monitoring the resources allocated by the network and those in use, the method allows the device to determine a subset of capabilities required for communication. This subset is then used to construct a partial UCI message, which is transmitted in response to subsequent UCI requests while the device remains in the same LAC.

This approach significantly reduces the size of the UCI message, which in turn decreases the transmission time and power consumption. This is particularly beneficial in areas with weak coverage, where large messages may fail to transmit successfully or cause delays in establishing network connections. By sending only the necessary information, the method enhances the efficiency of the communication process and improves the overall user experience.

Additionally, the method can include the use of the guard timer to account for network configuration changes, ensuring that the partial UCI message remains valid within the guard period. This further optimizes the process by preventing unnecessary full UCI transmissions, thus maintaining the benefits of reduced message size and improved transmission efficiency over time.

Advantageously, in one or more embodiments a system dynamically determines the contents of the UCI message based on real-time resource monitoring on a per-LAC basis. The system monitors the resources allocated by the network and the resources in use at a given location.

The system marks the resources that are actually exercised as IEs for the next UCI message in the same LAC. The system builds and stores a partial UCI message using these IEs. When the network requests UCI again within the same LAC, the system transmits the partial UCI message, thus reducing the size of the UCI message.

The system applies the same principle to reduce the capability of the device based on real-time monitoring of resource usage. The system monitors the capabilities in use and reports a reduced capability list, which includes elements such as the actual band or CA combination used, power class, inter-RAT band lists, MIMO layers, modulation schemes, and bandwidth.

In one or more embodiments, an electronic device comprises a communication device, a memory, and one or more processors operable with the communication device and the memory. The one or more processors dynamically reduce the size of a UCI message as a function of real-time resource assignment and utilization.

In one or more embodiments, the processors monitor resources allocated to the communication device by a network with which the communication device is in communication while the electronic device remains within an identified LAC. After the communication device initially sends a full UCI message upon the electronic device entering the LAC, the processors subsequently cause the communication device to transmit a partial UCI message on a per RAT basis in response to UCI requests from the network. In one or more embodiments. the partial UCI message comprises resources marked as IEs and/or IE values.

In one or more embodiments, the electronic device further comprises a guard timer. Where included, the one or more processors can initiate the guard timer upon constructing the partial UCI message. The processors only subsequently cause the communication device to transmit the partial UCI message while the guard timer remains unexpired. The partial UCI message further comprises one or more capability reductions of the electronic device.

Advantageously, this arrangement allows the electronic device to adaptively manage the size of UCI messages, thereby reducing the transmission time and power consumption associated with sending large UCI messages. By monitoring the network resources in real-time and only transmitting the necessary information elements, the device can ensure efficient communication, particularly in scenarios with weak coverage or limited battery life. This dynamic adjustment helps maintain a stable and efficient connection with the network, improving the overall user experience by reducing delays and conserving energy. Additionally, the use of a partial UCI message tailored to the specific RAT in use ensures that the device can effectively communicate its capabilities without overwhelming the network with unnecessary data. This method also mitigates the need for message segmentation and reassembly, which can introduce further delays and complexity.

In one or more embodiments, a method involves determining, by one or more processors, that the electronic device has entered a new LAC. Upon this determination, the one or more processors cause a communication device to transmit a full UCI message to the network in response to receiving a UCI request from the network.

Thereafter, the one or more processors monitor network resource assignments and utilization, marking assigned resources as IEs and/or IE values, which are stored as partial UE capability information in a memory of the electronic device. In one or more embodiments, the method further includes constructing, by the one or more processors, a partial UCI message from the IEs and/or the IE values. While the electronic device remains within the same LAC, the one or more processors, in response to subsequent UCI requests from the network, transmit the partial UCI message to the network instead of the full UCI message.

This approach ensures that the UCI message size is dynamically reduced based on real-time resource monitoring, thereby optimizing transmission efficiency and reducing power consumption. Additionally, the partial UCI message defines one or more UE capability reductions can be only transmitted while a guard timer, initiated after constructing the partial UCI message, remains unexpired. This guard timer accounts for potential network configuration changes, ensuring that the partial UCI message remains valid within the guard period. If the LAC changes or the guard timer expires, the method resumes by transmitting a full UCI message and repeating the monitoring and reduction steps.

Constructing a partial UCI message from the mandatory IEs and/or IE values reduces the size of the UCI message for subsequent transmissions. This reduction in message size decreases the transmission time and power consumption, which is particularly beneficial in areas with weak coverage or when the device has limited battery life. The partial UCI message still provides the network with the essential information needed to maintain efficient communication, without the overhead of transmitting a full UCI message each time.

The use of a guard timer ensures that the partial UCI message remains valid within a specified period, accounting for potential network configuration changes. This mechanism prevents unnecessary full UCI transmissions, further optimizing the communication process by maintaining the benefits of reduced message size and improved transmission efficiency over time. Overall, this method enhances the efficiency of the communication process, reduces power consumption, and improves the overall user experience by ensuring that the device transmits only the necessary information based on real-time network conditions and resource usage.

Thus, as described below a method in wireless communication involves dynamically reducing the size of the UCI message based on real-time resource assignment and utilization. The device monitors, on a per-LAC basis, the network resource assignments and utilization. The device marks resources as IEs in the UCI, such as the serving band and CA combinations used in both downlink (DL) and uplink (UL) paths.

In one or more embodiments, the device then builds and stores a partial UCI message based on these IEs and starts a guard timer against network configuration changes. When the network requests UCI within the same LAC and within the guard period, the device signals the network with the partial UCI message. In one or more embodiments, if the LAC changes or the guard timer expires, the device sends a full UCI message and resumes the learning process for the new LAC.

In one or more embodiments, the same principle applies to reducing the capability of the device based on real-time monitoring of resource usage, referred to as Reduced Capability (RedCap) UE. The device monitors capabilities in use and reports a reduced capability list, which includes elements such as the UE power class, the number of multiple input and multiple output (MIMO) layers used in both DL and UL, the modulation scheme in both DL and UL, the bandwidth used in both DL and UL, and the subcarrier spacing in both DL and UL.

This approach ensures that the device only reports the necessary capabilities, thereby reducing the size of the UCI message and improving transmission efficiency. Other advantages will be described below. Still others will be obvious to those of ordinary skill in the art having the benefit of this disclosure.

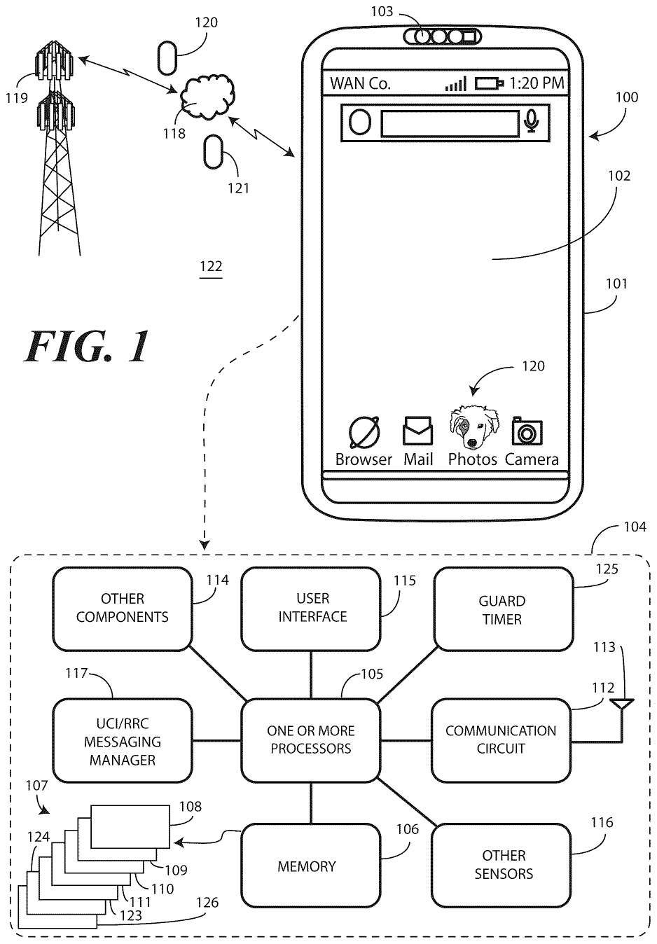

Turning now to FIG. 1, illustrated therein is one explanatory electronic device 100, referred to as “user equipment” (UE), configured in accordance with one or more embodiments of the disclosure. The electronic device 100 of FIG. 1 is a portable electronic device. For illustrative purposes, the electronic device 100 is shown as a smartphone. However, the electronic device 100 could be any number of other devices as well, including tablet computers, gaming devices, laptop computers, desktop computers, servers, networked computers, multimedia players, and so forth. Still other types of electronic devices can be configured in accordance with one or more embodiments of the disclosure as will be readily appreciated by those of ordinary skill in the art having the benefit of this disclosure.

The electronic device 100 includes a device housing 101. In one or more embodiments the device housing 101 is manufactured from a rigid material such as a rigid thermoplastic, metal, or composite material, although other materials can be used. In other embodiments, the device housing 101 can have a flexible display coupled thereto that slides around major and minor surface of the device housing 101.

In still other embodiments, the device housing 101 will be manufactured from a flexible material such that it can be bent and deformed. Where the device housing 101 is manufactured from a flexible material or where the device housing 101 includes a hinge, the display 102 can be manufactured on a flexible substrate such that it bends. Still other constructs will be obvious to those of ordinary skill in the art having the benefit of this disclosure.

In the illustrative embodiment of FIG. 1, the electronic device 100 includes a single device housing 101. However, in other embodiments two or more device housings can be included. Illustrating by example, in other embodiments an electronic device includes a first device housing and a second device housing. In one or more embodiments, a hinge assembly couples the first device housing to the second device housing. In one or more embodiments, the first device housing is selectively pivotable about the hinge assembly relative to the second device housing. For example, in one or more embodiments the first device housing is selectively pivotable about the hinge assembly between a closed position and an axially displaced open position. In still other embodiments, multiple hinges can be incorporated into the electronic device to allow it to be folded in multiple locations.

This illustrative electronic device 100 of FIG. 1 includes a display 102. The display 102 can optionally be touch sensitive. In one embodiment where the display 102 is touch sensitive, the display 102 can serve as a primary user interface 115 of the electronic device 100. Users can deliver user input to the display 102 of such an embodiment by delivering touch input from a finger, stylus, or other objects disposed proximately with the display 102.

In one embodiment, the display 102 is configured as an organic light emitting diode (OLED) display fabricated on a substrate. Where the electronic device 100 is flexible or deformable or hinged, the substrate can comprise flexible plastic substrate, thereby making the display 102 a flexible display or foldable display that deforms when the first device housing pivots about the hinge assembly relative to the second device housing.

In one embodiment, the display 102 is configured as an active-matrix organic light emitting diode (AMOLED) display. However, it should be noted that other types of displays, including liquid crystal displays, would be obvious to those of ordinary skill in the art having the benefit of this disclosure.

Features can be incorporated into the device housing 101. Examples of such features include an imager 103 or an optional speaker port. A user interface component, which may be a button or touch sensitive surface, can also be disposed along the device housing 101. Other features can be added as well.

In one or more embodiments, the imager 103 is configured as an intelligent imager. Where configured as an intelligent imager, the imager 103 can capture one or more images of environments about the electronic device 100 to determine whether the object matches predetermined criteria. For example, the imager 103 can operate as an identification module configured with optical recognition such as image recognition, character recognition, visual recognition, facial recognition, color recognition, shape recognition and the like.

A block diagram schematic 104 of the electronic device 100 is also shown in FIG. 1. The block diagram schematic 104 can be configured as a printed circuit board assembly disposed within the device housing 101 of the electronic device 100. Various components can be electrically coupled together by conductors, or a bus disposed along one or more printed circuit boards.

It should be noted that the block diagram schematic 104 includes many components that are optional, but which are included in an effort to demonstrate how varied electronic devices configured in accordance with embodiments of the disclosure can be. Thus, it is to be understood that the block diagram schematic 104 of FIG. 1 is provided for illustrative purposes only and for illustrating components of one electronic device 100 in accordance with embodiments of the disclosure. The block diagram schematic 104 of FIG. 1 is not intended to be a complete schematic diagram of the various components required for an electronic device 100. Therefore, other electronic devices in accordance with embodiments of the disclosure may include various other components not shown in FIG. 1 or may include a combination of two or more components or a division of a particular component into two or more separate components, and still be within the scope of the present disclosure.

In one or more embodiments, the electronic device 100 includes one or more processors 105. The one or more processors 105 can be a microprocessor, a group of processing components, one or more Application Specific Integrated Circuits (ASICs), programmable logic, or other type of processing device. The one or more processors 105 can be operable with the various components of the electronic device 100. The one or more processors 105 can be configured to process and execute executable software code to perform the various functions of the electronic device 100. A storage device, such as memory 106, can optionally store the executable software code used by the one or more processors 105 during operation.

In one or more embodiments, the one or more processors 105 are further responsible for performing the primary functions of the electronic device 100. For example, in one embodiment the one or more processors 105 comprise one or more circuits operable to present presentation information, such as images, text, and video, on the display 102. The executable software code used by the one or more processors 105 can be configured as one or more modules 107 that are operable with the one or more processors 105. Such modules 107 can store instructions, control algorithms, and so forth.

In one embodiment, the one or more processors 105 are responsible for running the operating system environment 108. The operating system environment 108 can include a kernel, one or more drivers 109, and an application service layer 110, and an application layer 111. The operating system environment 108 can be configured as executable code operating on one or more processors or control circuits of the electronic device 100.

In one or more embodiments, the one or more processors 105 are responsible for managing the applications of the electronic device 100. The applications of the application layer 111 can be configured as clients of the application service layer 110 to communicate with services through application program interfaces (APIs), messages, events, or other inter-process communication interfaces.

In this illustrative embodiment, the electronic device 100 also includes a communication device 112 that can be configured for wired or wireless communication with one or more other devices or networks 118. The networks can include a wide area network, a local area network, and/or personal area network. The communication device 112 may also utilize wireless technology for communication, such as, but are not limited to, peer-to-peer or ad hoc communications, and other forms of wireless communication such as infrared technology. The communication device 112 can include wireless communication circuitry, one of a receiver, a transmitter, or transceiver, and one or more antennas 113.

The one or more antennas 113 can take a variety of forms. Using 5G communication as an example, the one or more antennas 113 can comprise a MIMO antenna array comprising a plurality of antenna elements configured for MIMO communication with other remote electronic devices, servers, base stations, and so forth, across a network 118. Illustrating by example, the MIMO antenna array might consist of four antenna elements. However, it should be noted that embodiments of the disclosure the electronic device 100 can be equipped with six antenna element, eight antenna element, or higher numbers of antenna elements.

In one or more embodiments, the one or more antennas 113 also include at least one mmWave antenna assembly. In one or more embodiments, the mmWave antenna assembly comprises an array of mmWave antenna elements. In one or more embodiments, the array of mmWave antenna elements defines a N×1 matrix, where N represents a number of mmWave antenna elements of the array of mmWave antenna elements. Other antenna configurations for communicating with the network 118 will be obvious to those of ordinary skill in the art having the benefit of this disclosure.

In one or more embodiments, a UCI/RRC messaging manager 117 is configured to dynamically reduce a size of a UCI message as a function of real-time resource assignment and utilization. In one or more embodiments, the UCI/RRC messaging manager 117 monitors resources allocated to the communication device 112 by a network device 119 with which the communication device 112 is in communication across a network 118. In one or more embodiments, the UCI/RRC messaging manager 117 monitors these allocated resources while the electronic device 100 remains within an identified LAC 122.

In one or more embodiments, after the communication device 112 initially sends a full UCI message 120 upon the electronic device 100 entering the LAC 122, the UCI/RRC messaging manager 117 subsequently causes the communication device 112 to transmit a partial UCI message 121 on a per-RAT basis in response to UCI requests from the network device 119. In one or more embodiments, the partial UCI message 121 comprises resources marked as mandatory IEs 123 and/or IE values 124. In one or more embodiments, the partial UCI message 121 further comprises one or more capability reductions 126 of the electronic device 100.

In one or more embodiments, the electronic device 100 further comprises a guard timer 125. In one or more embodiments, the one or more processors 105 and/or the UCI/RRC messaging manager 117 initiate the guard timer 125 upon constructing the partial UCI message 121. In one or more embodiments, the UCI/RRC messaging manager 117 only subsequently causes the communication device 112 to transmit the partial UCI message 121 while the guard timer 125 remains unexpired.

Various sensors 116 can be operable with the one or more processors 105. One example of a sensor that can be included with the various sensors 116 sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 105, to detect an object in close proximity with—or touching—the surface of the display 102 or the device housing 101 of the electronic device 100 by establishing electric field lines between pairs of capacitive sensors and then detecting perturbations of those field lines.

Another example of a sensor that can be included with the various sensors 116 is a geo-locator that serves as a location detector. In one embodiment, location detector determines location data. Location can be determined by capturing the location data from a constellation of one or more earth orbiting satellites, or from a network of terrestrial base stations to determine an approximate location. The location detector may also be able to determine location by locating or triangulating terrestrial base stations of a traditional cellular network, or from other local area networks, such as Wi-Fi networks.

Another example of a sensor that can be included with the various sensors 116 is an orientation detector operable to determine an orientation and/or movement of the electronic device 100 in three-dimensional space. Illustrating by example, the orientation detector can include an accelerometer, gyroscopes, or other device to detect device orientation and/or motion of the electronic device 100. Using an accelerometer as an example, an accelerometer can be included to detect motion of the electronic device. Additionally, the accelerometer can be used to sense some of the gestures of the user, such as one talking with their hands, running, or walking.

The orientation detector can determine the spatial orientation of an electronic device 100 in three-dimensional space by, for example, detecting a gravitational direction. In addition to, or instead of, an accelerometer, an electronic compass can be included to detect the spatial orientation of the electronic device 100 relative to the earth's magnetic field. Similarly, one or more gyroscopes can be included to detect rotational orientation of the electronic device 100.

Thus, the one or more sensors 116 can include one or more of an accelerometer, gyroscope, and/or inertial motion to determine an orientation of the electronic device 100 in three-dimensional space. This orientation determination can include measurements of azimuth, plumb, tilt, velocity, angular velocity, acceleration, and angular acceleration, of the device housing 101, or where the electronic device 100 is configured as a bendable electronic device, one of the first device housing or the second device housing.

In one or more embodiments, the orientation determination signals are delivered to the one or more processors 105, which report the determined orientations to the various modules, components, and applications operating on the electronic device 100. In one or more embodiments, the one or more processors 105 can be configured to deliver a composite orientation that is an average or other combination of the orientation of orientation determination signals indicative of a triggering event to these components.

Other components 114 operable with the one or more processors 105 can include output components such as video outputs, audio outputs, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio outputs such as a loudspeaker disposed behind a speaker port or other alarms and/or buzzers and/or a mechanical output component such as vibrating or motion-based mechanisms.

Other components 114 of the electronic device 100 may include a microphone, an earpiece speaker, a loudspeaker, key selection sensors, a touch pad sensor, a touch screen sensor, a capacitive touch sensor, and one or more switches. Touch sensors may be used to indicate whether any of the user actuation targets present on the display are being actuated. Alternatively, touch sensors disposed along the device housing 101 can be used to determine whether the electronic device 100 is being touched at side edges or major faces of the electronic device 100 by a surface, hands, keys, or other objects. The touch sensors can include surface and/or housing capacitive sensors in one embodiment.

The other components 114 included with the electronic device 100 can also include motion detectors, such as one or more accelerometers or gyroscopes. For example, an accelerometer may be embedded in the electronic circuitry of the electronic device 100 to show vertical orientation, constant tilt and/or whether the electronic device 100 is stationary. The measurement of tilt relative to gravity is referred to as “static acceleration,” while the measurement of motion and/or vibration is referred to as “dynamic acceleration.” A gyroscope can be used in a similar fashion. In one embodiment the motion detectors are also operable to detect movement, and direction of movement, of the electronic device 100 by a user.

In one or more embodiments, the other components 114 include a gravity detector. For example, as one or more accelerometers and/or gyroscopes may be used to show vertical orientation, constant, or a measurement of tilt relative to gravity. The other components 114 operable with the one or more processors 105 can include output components such as video outputs, audio outputs, and/or mechanical outputs. Examples of output components include audio outputs, an earpiece speaker, haptic devices, or other alarms and/or buzzers and/or a mechanical output component such as vibrating or motion-based mechanisms. Still other components will be obvious to those of ordinary skill in the art having the benefit of this disclosure.

The other components 114 can also include proximity sensors. The proximity sensors fall into one of two camps: active proximity sensors and “passive” proximity sensors. Either the proximity detector components or the proximity sensor components can be generally used for gesture control and other user interface protocols.

The other components 114 can optionally include a barometer operable to sense changes in air pressure due to elevation changes or differing pressures of the electronic device 100. The other components 114 can also optionally include a light sensor that detects changes in optical intensity, color, light, or shadow in the environment of an electronic device. This can be used to make inferences about operating contexts of the electronic device 100 such as weather or colors, walls, fields, and so forth, or other cues.

An infrared sensor can be used in conjunction with, or in place of, the light sensor. The infrared sensor can be configured to detect thermal emissions from an environment about the electronic device 100. Similarly, a temperature sensor can be configured to monitor temperature about an electronic device.

In one or more embodiments, the UCI/RRC messaging manager 117 can be equipped with a device context determination manager to detect, infer, capture, and otherwise determine persons and actions that are occurring in an environment about the electronic device 100. For example, where included one embodiment of the device context determination manager determines assessed contexts and frameworks using adjustable algorithms of context assessment employing information, data, and events.

These assessments may be learned through repetitive data analysis. Alternatively, a user may employ a menu or user controls via the display 102 to enter various parameters, constructs, rules, and/or paradigms that instruct or otherwise guide the UCI/RRC messaging manager 117 when to utilize the partial UCI message 121. Illustrating by example, the user may actuate the location detector to allow the UCI/RRC messaging manager 117 to determine whether a new LAC has been entered. Where included the device context determination manager of the UCI/RRC messaging manager 117 can comprise an artificial neural network or other similar technology in one or more embodiments.

In one or more embodiments, the UCI/RRC messaging manager 117 is operable with the one or more processors 105. In some embodiments, the one or more processors 105 can control the UCI/RRC messaging manager 117.

In other embodiments, UCI/RRC messaging manager 117 can operate independently. The UCI/RRC messaging manager 117 can receive data from the various sensors 116. In one or more embodiments, the one or more processors 105 are configured to perform the operations of the UCI/RRC messaging manager 117.

In one or more embodiments, UCI/RRC messaging manager 117 starts the guard timer 125 upon entering a LAC 122 and sending a full UCI message 120 initially. In one or more embodiments, while the device is inactive, the UCI/RRC messaging manager 117 performs short throughput tests in both downlink and uplink directions to determine the actual capacity.

As used in this context, “inactive” means that no active application is operating in the foreground and exchanging data with the network 118. In this context, inactive is different from idle, which can imply situations where the electronic device 100 is not tied to the network 118. Thus, inactive may refer to situations where the electronic device 100 is not in use, has the display 102 turned OFF, is locked, or is in a low-power or sleep mode of operation.

In one or more embodiments, the UCI/RRC messaging manager 117 marks the resources that are actively used as IEs 123 for the next, partial UCI message 121 in the same LAC 122. This process allows the UCI/RRC messaging manager 117 to build and store the partial UCI message 121, which is transmitted in response to subsequent UCI requests within the same LAC 122, thereby reducing the size of the UCI message.

In one or more embodiments, the inclusion of the UCI/RRC messaging manager 117 offers dual benefits in the overall system, namely, reducing the UCI message size and reducing UE capability 126 reporting. In one or more embodiments, the UCI/RRC messaging manager 117 monitors the capabilities in use and reports a reduced capability list, including elements such as the actual band or CA combination used, power class, inter-RAT band lists, MIMO layers, modulation schemes, and bandwidth.

Advantageously, the UCI/RRC messaging manager 117 ensures that only the necessary capabilities are reported, optimizing transmission efficiency and reducing power consumption. The UCI/RRC messaging manager 117 thus improves the overall user experience, particularly in areas with weak coverage or limited battery life.

In other embodiments, rather than running a throughput test while the electronic device 100 is inactive, the UCI/RRC messaging manager 117 can instead monitor throughput-while the device is in use. In so doing, the UCI/RRC messaging manager 117 can use actual device performance over time instead of performing an affirmative test.

In one or more embodiments, the UCI/RRC messaging manager 117 measures channel usage that are the result of user actions, e.g., streaming video. Indeed, in one or more embodiments the UCI/RRC messaging manager 117 can monitor anything that utilizes the channel that causes data transfer. In one or more embodiments, the UCI/RRC messaging manager 117 can infer from that activity what resources have been assigned by the network device 119.

However, embodiments of the disclosure contemplate that performing a throughput test while the electronic device 100 is inactive is preferable because obtaining network usage capability from an application is imperfect. This is true because the UCI/RRC messaging manager 117 is not aware of how much data an application in use is transferring. Thus, having the UCI/RRC messaging manager 117 perform an affirmative throughput test is preferred. However, dynamic monitoring by the UCI/RRC messaging manager 117 when the electronic device 100 is in use can be used where precision is not required.

In one or more embodiments, the throughput tests performed by the UCI/RRC messaging manager 117 target the highest possible bandwidth and throughput to determine an amount of data that can be channeled across the network 118. Embodiments of the disclosure contemplate that when an application is known to do a longer data transfer at a known data rate, it could serve as a proxy for throughput to the UCI/RRC messaging manager 117.

Thus, in one or more embodiments the UCI/RRC messaging manager 117 determines that the electronic device 100 has entered a new LAC. In one or more embodiments, the UCI/RRC messaging manager 117 causes, in response to receipt of a UCI request from a network 118, the communication device 112 to transmit a full UCI message 120 to the network 118.

In one or more embodiments, the UCI/RRC messaging manager 117 thereafter monitor network resource assignments and utilization and marking assigned resources as mandatory IEs 123 and/or IE values 124 as partial UE capability information in the memory 106 of the electronic device 100. In one or more embodiments, the UCI/RRC messaging manager 117 then constructs a partial UCI message 121 from the mandatory IEs 123 and/or the IE values 124. In one or more embodiments, while the LAC 122 within which the electronic device 100 is operating remains unchanged, in response to subsequent UCI requests from the network 118, the UCI/RRC messaging manager 117 causes the communication device 112 to transmit the partial UCI message 121 to the network 118 instead of the full UCI message 120.

In one or more embodiments, the partial UCI message 121 defines one or more UE capability 126 reductions. Thus, the same principle can be applied to reducing the capability of the electronic device 100 based on real time monitoring of RedCap, UE power class, number of MIMO layers (DL/UL), modulation scheme (DL/UL), bandwidth used (DL/UL), subcarrier spacing (DL/UL), or combinations thereof. In one or more embodiments, the partial UCI message 121 is only transmitted while the guard timer 125, initiated after the constructing the partial UCI message 121 occurs, remains unexpired.

It is to be understood that FIG. 1 is provided for illustrative purposes only and for illustrating components of one electronic device 100 in accordance with embodiments of the disclosure and is not intended to be a complete schematic diagram of the various components required for an electronic device. Therefore, other electronic devices configured in accordance with embodiments of the disclosure may include various other components not shown in FIG. 1 or may include a combination of two or more components or a division of a particular component into two or more separate components, and still be within the scope of the present disclosure.

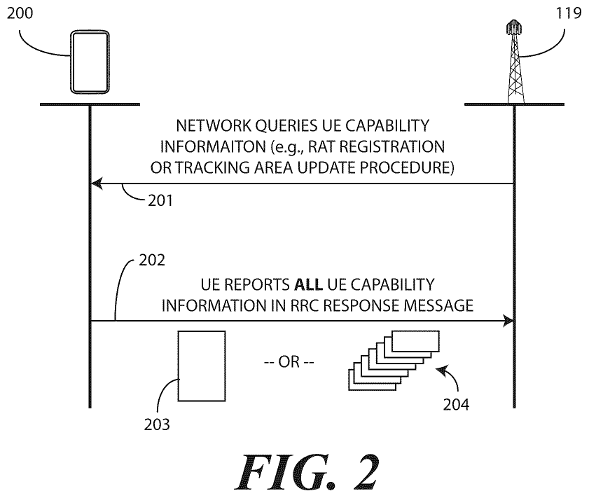

Turning now to FIG. 2, illustrates a flow chart for a UE capability update method. The flow chart includes UE 200 and a network device 119. The UE 200 can be a mobile phone or other device, as described above with reference to FIG. 1. The network device 119 may be a part of a wireless communication network (e.g., a Long Term Evolution (LTE) network, an LTE-Advanced network, an LTE-Advanced Pro network, a 5th Generation (5G) network, a New Radio (NR) network, an Internet of Things (IoT) network or a Narrow Band Internet of Things (NB-IoT) network). The network device 119 may be implemented as a cell, a base station, an evolved node B (eNB) or a gNB of the wireless communication network.

When the network device 119 needs additional UE radio access capability information, the network device 119 sends UE capability inquiry to a UE 200 to query UE capability information. The UE 200 then reports all UE capability information 202 in response to the query of the network in the form of a UCI message 203. When configuring the UE 200 or scheduling the UE 200, the network respects radio access capability parameters reported by the UE 200.

When the UE 200 is powered on or moves to the coverage of network device 119, the UE 200 may be configured to establish a RRC connection with network device 119 to acquire services. During an initial registration process, network device 119 may be configured to transmit a UE capability inquiry 201 message to the UE 200 to acquire UE's capabilities 201, as previously described.

After receiving the UE capability inquiry 201 message, the UE 200 may be configured to transmit its UE capability information 202 to the network device 119. Additionally, the networked device 119 may be configured to transmit an RRC connection reconfiguration message to the UE 200 to reconfigure the RRC connection. However, as 3rd Generation Partnership Project (3GPP) release version (e.g., LTE or NR) goes higher, more and more features may be added and supported by the UE 200. As noted above, the UE capability information 202 may become larger and complicated.

In a case that the network device 119 may not be updated as fast as the UE 200, the network device 119 may not even be compatible with the UE 200. For example, when the size of the UE capability information 202 exceeds an expected value supported by some network devices, the same may be unable to deal with the UE capability information 201. The RRC connection may not be set up or maintained for such network situations. The UE 200 may be unable to receive services from such network apparatus.

In situations where the network device 119 is configured to receive large UCI messages 203, modern messages can be as large as 2 KB to 8 KB. These excessive sizes of the UCI message 203 pose challenges in terms of transmission time, power consumption, and successful reception, especially in areas with weak coverage. The increasing complexity of these messages is particularly pronounced in new systems, where the number of aggregated carriers and supported features can exceed the maximum size of signaling messages, thereby introducing additional delays as the network reassembles the segments.

While some networks allow the UCI message 203 to be segmented into UCI message segments 204, this introduces additional delays as the network device 119 reassembles the UCI message segments 204. Moreover, this segmentation process can negatively impact the user experience by delaying the establishment of connections and increasing power consumption. Additionally, the large size of these messages can lead to transmission failures, especially in areas with weak coverage, further complicating the process of establishing and maintaining network connections.

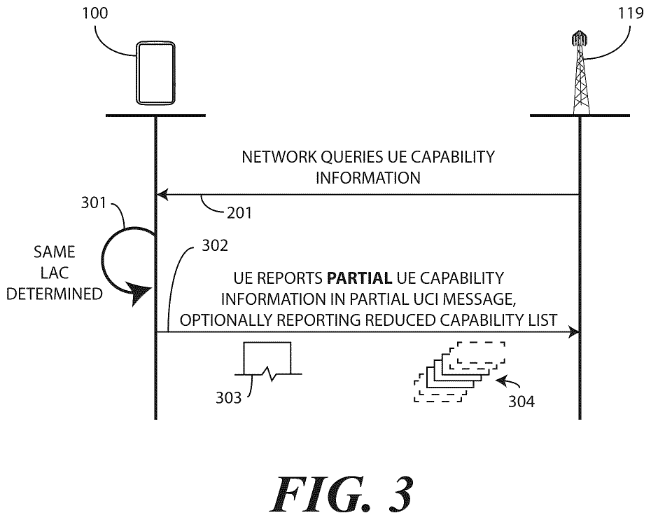

Turning now to FIG. 3, illustrated therein is an explanatory signaling diagram that address these challenges by dynamically reducing the size of UCI messages based on real-time resource monitoring. Upon entering a new LAC, UE configured as an electronic device 100 in accordance with embodiments of the disclosures transmits a full UCI message (203) to the network in response to an initial UE capability inquiry 201 message.

In contrast to the signaling diagram of FIG. 2, where full UCI messages (203) are always transmitted in response to UE capability inquiry 201 messages, in FIG. 3, and while the UE remains in the same LAC as determined by operation 301, the UE performs a short throughput test in both downlink and uplink directions while the electronic device 100 is inactive. As described above, one or more processors of the UE mark the resources that are actually exercised as IEs for the next UCI message in the same LAC.

In one or more embodiments, the UE then builds and stores a partial UCI message 303 using these IEs. When the network device 119 requests UCI again within the same LAC via a UE capability inquiry 201 message, the UE transmits 301 only the partial UCI message 303 (or partial segments 304 of the partial UCI message 303). Advantageously, this reducing the size of the transmitted UCI message.

In one or more embodiments, the UE also monitors the capabilities in use and reports a reduced capability list to the network device 119. In one or more embodiments, the reduced capabilities list includes elements such as the actual band or CA combination used, power class, inter-RAT band lists, MIMO layers, modulation schemes, and bandwidth.

In one or more embodiments, the UE utilizes the process at all times. In other embodiments the UE uses the process only in weak coverage or when the remaining battery charge level is low.

As described above, in one or more embodiments the UE starts a guard timer to account for network configuration changes. Initiation of this timer ensures that the partial UCI message 303 remains valid within the guard period. In one or more embodiments, if the LAC changes or the guard timer expires, the UE reinitializes the process by transmitting a full UCI message (203) and repeating the monitoring and reduction steps.

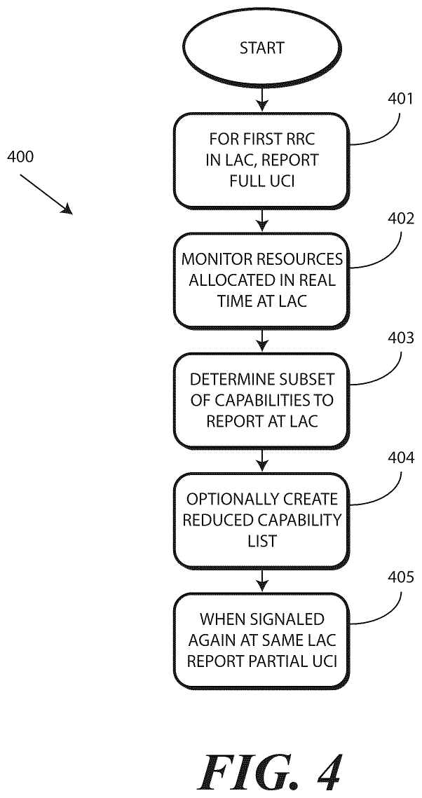

Turning now to FIG. 4, illustrated therein is one explanatory method 400 in accordance with one or more embodiments of the disclosure. Principal steps of the method 400 include transmitting, by a communication device of an electronic device, a full UCI message at step 401 in response to the communication device receiving a UCI request from at least one network device across a network upon the electronic device entering a new LAC, thereafter, while the electronic device remains in the LAC, monitoring, by one or more processors, resources allocated by the network and resources in use by the one or more processors at step 402, determining, in response to the monitoring, a subset of capabilities required by the electronic device to communicate across the network at step 403, and in response to the communication device receiving another UCI request while the electronic device remains in the LAC, causing, by the one or more processors, the communication device to transmit a partial UCI message to the at least one network device across the network at step 405.

Beginning with step 401, upon entering a new LAC, the communication device of an electronic device transmits a full UCI message in response to receiving a UCI request from at least one network device across a network. In one or more embodiments, step 401 begins when the electronic device detects that the electronic device has entered a new LAC, which triggers the communication device to prepare for transmitting the full UCI message.

In one or more embodiments, the network device, which may be part of a wireless communication network such as LTE, 5G, or NR, sends a UCI request to the electronic device to query the electronic device's capabilities. This request is typically part of the initial registration or update procedures that occur when the device connects to a new cell or base station within the network.

In one or more embodiments, the full UCI message transmitted at step 401 includes comprehensive information about the device's capabilities, which the network uses to optimize communication and resource allocation. Examples of information included in a full UCI message are the supported CA band combinations, feature group indicators (FGI), power class, the number of MIMO layers, modulation schemes, and bandwidth capabilities. The message may also contain details about the device's support for various RATs, such as LTE, NR, and their respective configurations.

The transmission of the full UCI message at step 401 ensures that the network has a complete understanding of the device's capabilities, allowing the network to make informed decisions about resource allocation and service provisioning. This comprehensive information is used for maintaining efficient and reliable communication, especially in scenarios where the network needs to manage multiple devices with varying capabilities. By transmitting the full UCI message upon entering a new LAC at step 401, the electronic device ensures that the network can optimize network operations based on the most accurate and up-to-date information about the device's capabilities.

At step 402 of FIG. 4, while the electronic device remains in the LAC, one or more processors of the electronic device monitor resources allocated by the network and resources in use by the one or more processors. In one or more embodiments, this monitoring process involves marking the resources allocated by the network as information elements (IEs) and/or IE values.

In one or more embodiments, these IEs and/or IE values are stored as partial UCI information in a memory of the electronic device. The monitoring process occurring at step 402 ensures that the electronic device keeps track of the specific resources that are actively utilized, allowing for the construction of a partial UCI message at step 404 that accurately reflects the current operational state of the device.

In addition to marking the allocated resources as IEs and/or IE values, other monitoring operations may optionally be performed at step 403 For instance, the one or more processors may perform a data throughput test in both downlink and uplink directions to determine the actual capacity of the network resources at step 403. This test can be conducted while the electronic device is otherwise inactive, such as when the display is OFF, or the device is in a low-power or sleep mode of operation. The results of the throughput test can provide insights into the network's performance and help in determining the subset of capabilities required for efficient communication.

Furthermore, the one or more processors may monitor the capabilities in use at step 403 and report a reduced capability list at step 404, which includes elements such as the actual band or CA combination used, power class, inter-RAT band lists, MIMO layers, modulation schemes, and bandwidth. This real-time monitoring of resource usage allows the electronic device to dynamically adjust the reported capabilities, ensuring that only the necessary information is transmitted in subsequent UCI messages. By optimizing the UCI message size based on real-time resource monitoring, the electronic device can enhance transmission efficiency, reduce power consumption, and improve the overall user experience.

At step 405 of FIG. 4, in response to the communication device receiving another UCI request while the electronic device remains in the LAC, the one or more processors can cause the communication device to transmit a partial UCI message to at least one network device across the network. This step can first comprise building the partial UCI message using the information elements (IEs). In one or more embodiments, the partial UCI message can include one or more of a serving band of the network, uplink carrier aggregation (UL CA) combinations supported by the communication device, and/or downlink carrier aggregation (DL CA) combinations supported by the communication device.

In some embodiments, step 405 can also comprise starting, by the one or more processors, a guard timer in response to building the partial UCI message. The guard timer ensures that the partial UCI message remains valid within a specified period, accounting for potential network configuration changes. Causing the communication device to transmit the UCI message may occur only when both the electronic device remains in the LAC between receipt of the UCI request and receipt of another UCI request and the guard timer remains unexpired. This mechanism prevents unnecessary full UCI transmissions, further optimizing the communication process by maintaining the benefits of reduced message size and improved transmission efficiency over time.

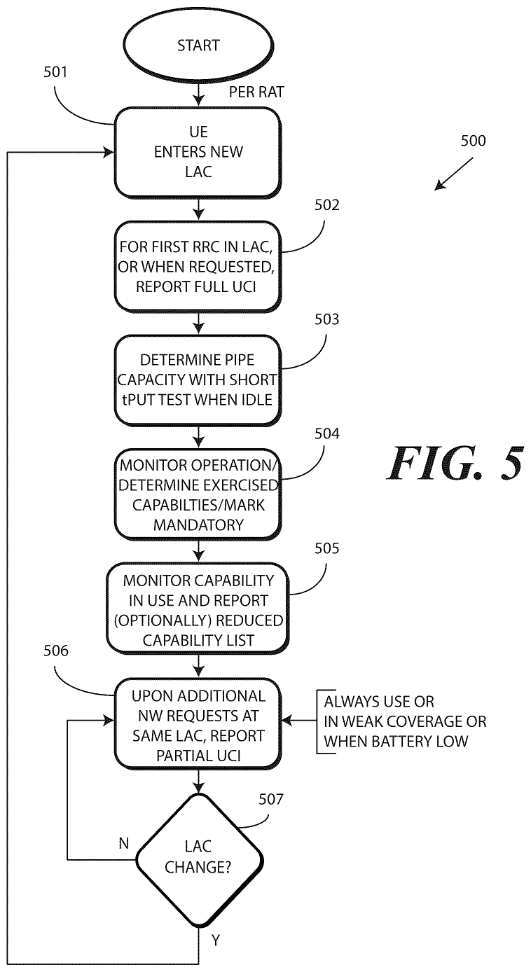

Turning now to FIG. 5, illustrated therein is another explanatory method 500 in accordance with one or more embodiments of the disclosure. The method 500 begins at step 501, where the electronic device initiates the process of dynamically reducing the size of the UCI message based on real-time resource monitoring by using location detection to determine that the UE has entered a new LAC. Said differently, at step 501, the electronic device, referred to as the user equipment (UE), enters a new location area code (LAC). This event triggers the need for the UE to update the network with the UE's capabilities. The UE detects the change in LAC and prepares to transmit a full UCI message to the network.

At step 502, the UE transmits a full UCI message in response to receiving a UCI request from the network. In one or more embodiments, this transmission occurs during the initial registration or update procedures when the UE connects to a new cell or base station within the network. The full UCI message includes comprehensive information about the UE's capabilities, such as supported CA band combinations, feature group indicators (FGI), power class, the number of MIMO layers, modulation schemes, and bandwidth capabilities. This step ensures that the network has a complete understanding of the UE's capabilities, allowing for optimized communication and resource allocation.

At step 503, while the UE is inactive, the one or more processors of the UE perform a short throughput test in both downlink and uplink directions to determine the actual pipe capacity. Said differently, in one or more embodiments step 503 comprises performing, by the one or more processors using the communication device, a data throughput test in both downlink and uplink directions.

In one or more embodiments, this test provides insights into the network's performance and helps in determining the subset of capabilities required for efficient communication. The throughput test targets the possible bandwidth and throughput to determine the amount of data that can be channeled across the network.

At step 504, the one or more processors of the UE monitor the operation of the device and determine the capabilities that are actually exercised. The processors mark these exercised capabilities as IEs for the next UCI message in the same LAC.

In one or more embodiments, this monitoring process at step 504 involves marking the resources allocated by the network as IEs and/or IE values, which are stored as partial UCI information in a memory of the UE. This step ensures that the UE keeps track of the specific resources that are actively utilized, allowing for the construction of a partial UCI message that accurately reflects the current operational state of the device.

In one or more embodiments, step 505 comprises the UE monitoring the capabilities in use and reporting a reduced capability list. In one or more embodiments, this list includes elements such as the actual band or CA combination used, power class, inter-RAT band lists, MIMO layers, modulation schemes, and bandwidth. This real-time monitoring of resource usage allows the UE to dynamically adjust the reported capabilities, ensuring that only the necessary information is transmitted in subsequent UCI messages. This step 505 optimizes the UCI message size based on real-time resource monitoring, enhancing transmission efficiency, reducing power consumption, and improving the overall user experience.

At step 506, in response to the communication device receiving another UCI request while the UE remains in the same LAC, the one or more processors cause the communication device to transmit a partial UCI message to the network. In one or more embodiments, the causing the communication device to transmit the partial UCI message at step 506 to the at least one network device across the network occurs when one or both of the throughput test performed at step 503 yields a throughput result below a predefined throughput threshold and/or an amount of energy stored in an energy storage device of the electronic device is below a predefined energy storage threshold.

In one or more embodiments, step 506 involves building the partial UCI message using the IEs and/or IE values. The partial UCI message can include one or more of a serving band of the network, uplink carrier aggregation (UL CA) combinations supported by the communication device, and/or downlink carrier aggregation (DL CA) combinations supported by the communication device.

In one or more embodiments, the partial UCI message further comprises a reduced capability list for the electronic device. In one or more embodiments, the partial UCI message comprises a subset of data of the UCI message and is constructed on a per RAT basis. In one or more embodiments, this step reduces the size of the transmitted UCI message, optimizing the communication process by maintaining the benefits of reduced message size and improved transmission efficiency over time.

Decision 507 then checks whether the LAC has changed. If the LAC has changed, the method returns to step 501, where the UE enters a new LAC and the process of transmitting a full UCI message and monitoring resources begins anew. If the LAC has not changed, the method proceeds to step 506.

It should be noted that step 506 can determine whether to use the process of dynamically reducing the UCI message size or to use the process only in specific conditions, such as in weak coverage or when the remaining battery charge level is low. This step 506, where so configured, ensures that the method 500 is applied in scenarios where the process is beneficial, optimizing transmission efficiency and reducing power consumption based on real-time network conditions and resource usage.

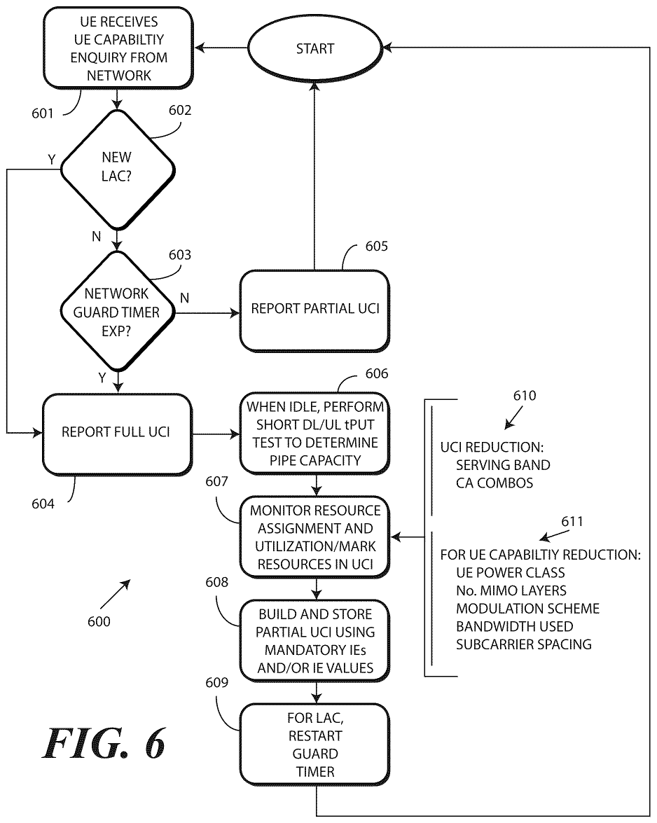

Turning now to FIG. 6, illustrated therein is another explanatory method 600 in accordance with one or more embodiments of the disclosure. FIG. 6 shows a method 600 for dynamically reducing the size of a UCI message based on real-time resource monitoring. The method 600 can be implemented by an electronic device, such as a mobile phone, tablet, or other wireless communication device.

At step 601, the UE receives a UE capability enquiry from the network. This enquiry prompts the UE to provide the UE capability information to the network.

At step 602, the method 600 determines whether the UE has entered a new LAC. If the UE has entered a new LAC, the method proceeds to step 604. If the UE has not entered a new LAC, the method proceeds to step 603.

At step 603, the method 600 checks whether the network guard timer has expired. If the guard timer has expired, the method proceeds to step 604. If the guard timer has not expired, the method proceeds to step 605.

At step 604, the UE reports a full UCI message to the network. This full UCI message includes comprehensive information about the UE's capabilities.

At step 605, the UE reports a partial UCI message to the network. This partial UCI message includes a subset of the UE's capabilities, which are determined based on real-time resource monitoring.

At step 606, when the UE is idle, the method 600 performs a short downlink (DL) and uplink (UL) throughput test to determine the pipe capacity. This test helps in assessing the network's performance and the UE's resource usage.

At step 607, the method 600 monitors resource assignment and utilization, marking the resources in the UCI. This monitoring helps in identifying the resources that are actively used by the UE.

At step 608, the method 600 builds and stores a partial UCI message using information elements (IEs) and/or IE values. This partial UCI message is constructed based on the resources marked in the previous step.

At step 609, the method 600 restarts the guard timer for the LAC. This ensures that the partial UCI message remains valid within the guard period.

Step 607 can include UCI reduction 610 for serving band and CA combinations. This reduction helps in optimizing the UCI message size. Step 607 can also include UE capability reduction 611 for various parameters such as UE power class, number of MIMO layers, modulation scheme, bandwidth used, and subcarrier spacing. This reduction further optimizes the UCI message size and improves transmission efficiency.

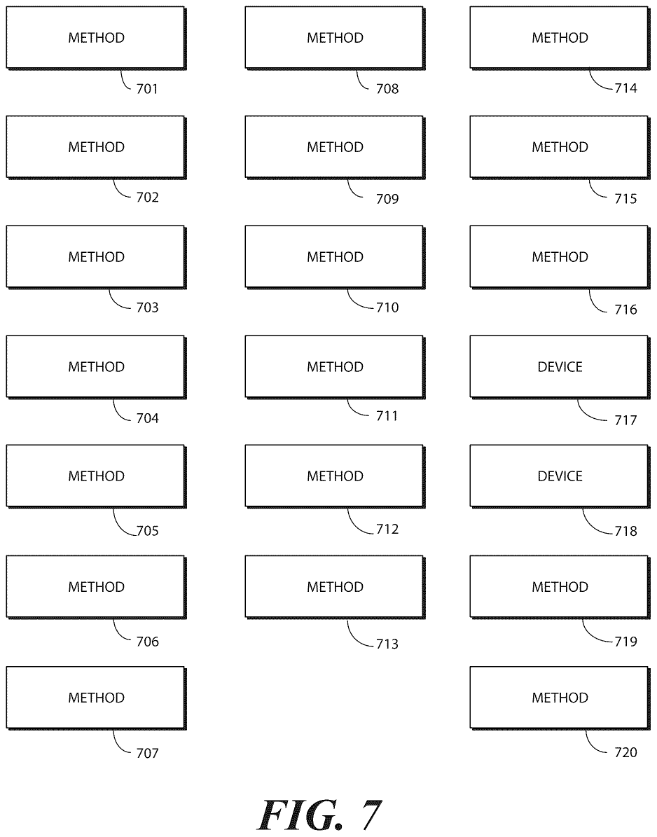

Turning now to FIG. 7, illustrated therein are various embodiments of the disclosure. The embodiments of FIG. 7 are shown as labeled boxes in FIG. 7 due to the fact that the individual components of these embodiments have been illustrated in detail in FIGS. 1-6, which precede FIG. 7. Accordingly, since these items have previously been illustrated and described, their repeated illustration is no longer essential for a proper understanding of these embodiments. Thus, the embodiments are shown as labeled boxes.

At 701 a method in an electronic device comprises transmitting, by a communication device of the electronic device, a full user equipment (UE) capability information (UCI) message in response to the communication device receiving a UCI request from at least one network device across a network upon the electronic device entering a new location area code (LAC). AT 701, the method comprises, thereafter, while the electronic device remains in the LAC, monitoring, by one or more processors, resources allocated by the network and resources in use by the one or more processors.

At 701, the method comprises determining, in response to the monitoring, a subset of capabilities required by the electronic device to communicate across the network. At 701, in response to the communication device receiving another UCI request while the electronic device remains in the LAC, the method comprises causing, by the one or more processors, the communication device to transmit a partial UCI message to the at least one network device across the network.

At 702, the monitoring of 701 comprises marking the resources allocated by the network as mandatory information elements (IEs) and/or IE values as partial UCI information stored in a memory of the electronic device. At 703, the method of 702 further comprises building the partial UCI message using the mandatory IEs. At 704, the partial UCI message of 702 comprises one or more of a serving band of the network, uplink carrier aggregation (UL CA) combinations supported by the communication device, and/or downlink carrier aggregation (DL CA) combinations supported by the communication device.

At 704, the method of 704 further comprises starting, by the one or more processors, a guard timer in response to building the partial UCI message. At 706, the causing the communication device to transmit the UCI message at 705 occurs only when both the electronic device remains in the LAC between receipt of the UCI request and receipt of another UCI request and the guard timer remains unexpired.

At 707, the method of 701 further comprises performing, by the one or more processors using the communication device, a data throughput test in both downlink and uplink directions. At 708, the causing the communication device to transmit the partial UCI message at 707 to the at least one network device across the network occurs when one or both of the throughput test yields a throughput result below a predefined throughput threshold and/or an amount of energy stored in an energy storage device of the electronic device is below a predefined energy storage threshold.

At 709, the performing the data throughput test of 707 occurs when the electronic device is otherwise inactive. At 710, the electronic device of 709 is otherwise inactive when a display of the device is OFF or in a sleep mode of operation. At 711, the electronic device of 709 is otherwise inactive when the electronic device is in a low-power or sleep mode of operation.

At 712, the partial UCI message of 707 further comprises a reduced capability list for the electronic device. At 713, the reduced capability list of 712 comprises one or more of a power class of the electronic device, a number of multiple input and multiple output (MIMO) layers used by the communication device, a modulation scheme of the communication device, a bandwidth of the communication device, and/or subcarrier spacing of the communication device. At 714, the partial UCI message of 701 comprises a subset of data of the UCI message and is constructed on a per radio access technology (RAT) basis.

At 715, an electronic device comprises a communication device, a memory, and one or more processors operable with the communication device and the memory. At 715, the one or more processors are configured to dynamically reduce a size of a user equipment (UE) capability information (UCI) message as a function of real-time resource assignment and utilization by monitoring resources allocated to the communication device by a network with which the communication device is in communication while the electronic device remains within an identified location area code (LAC). At 715, after the communication device initially sends a full UCI message upon the electronic device entering the LAC, the one or more processors subsequently cause the communication device to transmit a partial UCI message on a per radio access technology (RAT) basis in response to UCI requests from the network; wherein the partial UCI message comprises resources marked as mandatory information elements (IEs) and/or information element (IE) values.

At 716, the electronic device of 715 further comprises a guard timer. At 716, the one or more processors initiate the guard timer upon constructing the partial UCI message. At 717, the one or more processors of 716 only subsequently cause the communication device to transmit the partial UCI message while the guard timer remains unexpired. At 718, the partial UCI message of 715 further comprises one or more capability reductions of the electronic device.

At 719, a method in an electronic device comprises determining, by one or more processors, that the electronic device has entered a new location area code (LAC). At 719, the method comprises causing, by the one or more processors in response to receipt of a user equipment (UE) capability information (UCI) request from a network, a communication device to transmit a full UCI message to the network.

At 719, the method comprises thereafter monitoring, by the one or more processors, network resource assignments and utilization and marking assigned resources as mandatory information elements (IEs) and/or information element (IE) values as partial UE capability information in a memory of the electronic device. At 719, the method comprises constructing, by the one or more processors, a partial UCI message from the mandatory IEs and/or the IE values.

At 719, the method comprises, while the LAC within which the electronic device is operating remains unchanged, in response to subsequent UCI requests from the network, transmitting the partial UCI message to the network instead of the full UCI message. At 720, the partial UCI message of 719 defines one or more UE capability reductions and is only transmitted while a guard timer, initiated after the constructing the partial UCI message occurs, remains unexpired.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
transmitting, by a communication device of the electronic device, a full user equipment (UE) capability information (UCI) message in response to the communication device receiving a UCI request from at least one network device across a network upon the electronic device entering a new location area code (LAC);
thereafter, while the electronic device remains in the LAC, monitoring, by one or more processors, resources allocated by the network and resources in use by the one or more processors;
determining, in response to the monitoring, a subset of capabilities required by the electronic device to communicate across the network; and
in response to the communication device receiving another UCI request while the electronic device remains in the LAC, causing, by the one or more processors, the communication device to transmit a partial UCI message to the at least one network device across the network.

2. The method of claim 1, wherein the monitoring comprises marking the resources allocated by the network as mandatory information elements (IEs) and/or IE values as partial UCI information stored in a memory of the electronic device.

3. The method of claim 2, further comprising building the partial UCI message using the mandatory IEs.

4. The method of claim 2, wherein the partial UCI message comprises one or more of a serving band of the network, uplink carrier aggregation (UL CA) combinations supported by the communication device, and/or downlink carrier aggregation (DL CA) combinations supported by the communication device.

5. The method of claim 3, further comprising starting, by the one or more processors, a guard timer in response to building the partial UCI message.

6. The method of claim 5, wherein the causing the communication device to transmit the UCI message occurs only when both the electronic device remains in the LAC between receipt of the UCI request and receipt of the another UCI request and the guard timer remains unexpired.

7. The method of claim 1, further comprising performing, by the one or more processors using the communication device, a data throughput test in both downlink and uplink directions.

8. The method of claim 7, wherein the causing the communication device to transmit the partial UCI message to the at least one network device across the network occurs when one or both of the data throughput test yields a throughput result below a predefined throughput threshold and/or an amount of energy stored in an energy storage device of the electronic device is below a predefined energy storage threshold.

9. The method of claim 7, wherein the performing the data throughput test occurs when the electronic device is otherwise inactive.

10. The method of claim 9, wherein the electronic device is otherwise inactive when a display of the device is OFF or in a sleep mode of operation.

11. The method of claim 9, wherein the electronic device is otherwise inactive when the electronic device is in a low-power or sleep mode of operation.

12. The method of claim 7, wherein the partial UCI message further comprises a reduced capability list for the electronic device.

13. The method of claim 12, wherein the reduced capability list comprises one or more of a power class of the electronic device, a number of multiple input and multiple output (MIMO) layers used by the communication device, a modulation scheme of the communication device, a bandwidth of the communication device, and/or subcarrier spacing of the communication device.

14. The method of claim 1, wherein the partial UCI message comprises a subset of data of the UCI message and is constructed on a per radio access technology (RAT) basis.

15. An electronic device, comprising:
a communication device;
a memory; and
one or more processors operable with the communication device and the memory;
wherein the one or more processors are configured to dynamically reduce a size of a user equipment (UE) capability information (UCI) message as a function of real-time resource assignment and utilization by:
monitoring resources allocated to the communication device by a network with which the communication device is in communication while the electronic device remains within an identified location area code (LAC); and
after the communication device initially sends a full UCI message upon the electronic device entering the LAC, subsequently cause the communication device to transmit a partial UCI message on a per radio access technology (RAT) basis in response to UCI requests from the network;
wherein the partial UCI message comprises resources marked as mandatory information elements (IEs) and/or information element (IE) values.

16. The electronic device of claim 15, further comprising a guard timer, wherein the one or more processors initiate the guard timer upon constructing the partial UCI message.

17. The electronic device of claim 16, wherein the one or more processors only subsequently cause the communication device to transmit the partial UCI message while the guard timer remains unexpired.

18. The electronic device of claim 15, wherein the partial UCI message further comprises one or more capability reductions of the electronic device.

19. A method in an electronic device, the method comprising:
determining, by one or more processors, that the electronic device has entered a new location area code (LAC);
causing, by the one or more processors in response to receipt of a user equipment (UE) capability information (UCI) request from a network, a communication device to transmit a full UCI message to the network;
thereafter monitoring, by the one or more processors, network resource assignments and utilization and marking assigned resources as mandatory information elements (IEs) and/or information element (IE) values as partial UE capability information in a memory of the electronic device;
constructing, by the one or more processors, a partial UCI message from the mandatory IEs and/or the IE values; and
while the LAC within which the electronic device is operating remains unchanged, in response to subsequent UCI requests from the network, transmitting the partial UCI message to the network instead of the full UCI message.

20. The method of claim 19, wherein the partial UCI message defines one or more UE capability reductions and is only transmitted while a guard timer, initiated after the constructing the partial UCI message occurs, remains unexpired.
